(19) United States
(12) Patent Application Publication
(10) Pub. No.: US 2005/0181830 A1
(43) Pub. Date: Aug. 18, 2005

(54) Increasing frequency assignment (FA) and implementing beacon in small base station transceiver subsystem (BTS)

(76) Inventor: Jin-Kyu Lee, Seoul (KR)

Correspondence Address: Robert E. Bushnell;Attorney at Law, Suite 300, 1522 "K" Street, N.W., Washington, DC, 20005-1202, US

(21) Appl. No.: 11/028,865

(22) Filed: Jan. 5, 2005

(30) Foreign Application Priority Data
Feb. 13, 2004 (KR) 2004-9775

(51) Int. Cl. H04B 1/38

(52) U.S. Cl. 455/561; 455/73

(57) ABSTRACT

A Frequency Assignment (FA) is increased by adding an RF module included on a single board and a beacon function is effected by adding a beacon module included on a single board in designing a small-sized base station transceiver subsystem using a Code-Division Multiple Access (CDMA) scheme. It is possible to increase the FA by adding the RF module including a radio transceiver and a digital logic circuit on a single board separately from a small-sized base station transceiver subsystem in a small-sized base station transceiver subsystem without adding the small-sized base station transceiver subsystem. It is also possible to effect a beacon function for performing a handoff of a terminal by adding a beacon module included on a single board to the small-sized base station transceiver subsystem.

### CLAIM OF PRIORITY

This application makes reference to, incorporates the same herein, and claims all benefits accruing under 35 U.S.C. §119 from an application for SYSTEM AND METHOD FOR INCREASING FREQUENCY ASSIGNMENT (FA) AND IMPLEMENTING BEACON IN SMALL BASE STATION TRANSCEIVER SUBSYSTEM (BTS) earlier filed in the Korean Intellectual Property Office on 13 Feb., 2004 and there duly assigned Ser. No. 2004-9775.

### BACKGROUND OF THE INVENTION

1. Field of the Invention

The present invention relates to a small Base station Transceiver Subsystem (BTS) in a wireless communication system. In particular, the present invention relates to increasing a frequency assignment (FA) and implementing a beacon, where the FA is increased in a module shape and a beacon function is implemented in a small BTS using a Code-Division Multiple Access (CDMA) scheme.

2. Description of the Related Art

Wireless communication systems have been transformed from a conventional analog scheme to a digital scheme. The digital scheme provides a number of advantages, including increased capacity, greater security against fraud and more advanced services in order to solve some of the problems of the conventional analog scheme, and various kinds of technology have been developed. Among them, the most successful digital technologies are IS-136 (Interim Standard 136) Time Division Multiple Access (TDMA), IS-95 CDMA, and Global System for Mobile communications (GSM).

IS-136 was developed through a two-stage evolution from Analog Advanced Mobile Phone Service (AMPS). AMPS is a Frequency Division Multiple Access (FDMA) system, with each channel occupying 30 KHz. Some of the channels, known as control channels, are dedicated to control signaling and some of the channels, known as voice channels, are dedicated to carrying the actual voice conversation.

The first step in digitizing this system was the introduction of digital voice channels. This step involved the application of Time-Division Multiplexing (TDM) to the voice channels such that each voice channel was divided into time slots, enabling up to three simultaneous conversations on the same RF channel. This stage in the evolution was known as IS-54 B (also known as Digital AMPS or D-AMPS). That scheme is a Digital AMPS (D-AMPS) that is referred to as IS-54B. D-AMPS involves digital voice channels only, and still uses analog control channels.

IS-136 including digital control channels and digital voice channels was introduced in 1994. Today AMPS, IS-54B, and IS-136 are all in service. AMPS and IS-54 operate only in the 800-MHz band, whereas IS-136 can be found both in the 800 MHz band and in the 1900-MHz band, at least in North America. The 1900-MHz band in North America is allocated to Personal Communications Service (PCS), which can be described as a family of second-generation mobile communications services.

Although they have significant differences, both IS136 and GSM use Time Division Multiple Access (TDMA). This means that individual radio channels are divided into time slots, enabling a number of users to share a single RF channel on a time-sharing basis. Besides them, there is a Code-Division Multiple Access (hereinafter referred to as a CDMA) scheme where a number of users use one radio channel.

CDMA designates that a unique code is used in a method where limited frequency resources are divided between multiple users. The scheme becomes TDMA when an object to be divided is time, and FDMA when the object to be divided is a frequency. Its basic methodology is to use a spread spectrum, where CDMA has a merit of the spread spectrum scheme and enables a number of users to transmit and receive signals while enabling them to share the time and frequency commonly.

While the TDMA scheme cannot be called a perfect simultaneous use since it mechanically divides user's simultaneous conversations in time, the CDMA scheme can increase the subscriber accommodation capacity since a number of users can simultaneously use the same frequency.

While commercial technology of the digital mobile phone system of the CDMA scheme was developed recently, the theory of CDMA was already established in 1950 and has been used in a military communication from 1960's. The wiretapping protection is very important in the military communication, and spread spectrum technology that is a technical basis for the CDMA scheme was applied to the wiretapping protection of the military communication.

When CDMA is compared with FDMA or TDMA, it can be compared to a situation where many people are talking in a certain meeting place. That is, the FDMA scheme is explained as all people using the same language, and they enter into each of a group of conference rooms which are divided into small areas to talk after waiting for their orders. The TDMA scheme is explained as all people using the same language but they gather in the same place to talk, which is different from the FDMA scheme. In the TDMA scheme, however, all people are talking not simultaneously but in their allocated time after determining their talking time. Of course, while the talking seems to be interfered with since the time to talk is broken off, there is actually no difficulty in talking at all.

The CDMA scheme is explained as many people simultaneously talking in the same place in comparison with the other two schemes. However, they use different languages from one another, so that they understand the talking that is expressed with the language that he or she understands, and the talking that is expressed with other languages is regarded as a noise. The CDMA technology uses a band expansion communication technology that has been basically used for a long time, which largely increases the frequency usage efficiency in addition to all merits that the band expansion technology has.

Describing the above example technically, since it is possible to use the same frequency band in all service areas, a frequency reuse coefficient becomes 1 in view of a cellular concept so that the frequency usage efficiency becomes much higher than that of other methods. Also, since the same frequency band can be used in all service areas, it is possible to perform a handover. Furthermore, since the communication is performed using codes different from one another, there is a merit in that communication security of the radio region is excellent.

The CDMA method has the following properties. First of all, it has a large capacity. That is, since the same frequency can be used in many cells, there is less interference than other methods, and since the transmission can be stopped when persons on the line are silent, the CDMA method can increase the reception capacity more than 10 times as compared with the analog method.

Furthermore, a higher quality of service can be provided. In the analog method, signals are incoming through multiple paths, resulting in detremental effects on speech. However, in the CDMA method, since such multiple path signals are separated from one another and satisfactory signals are selected and used, its quality is superior to the analog method. Since it uses a soft handoff method where there is no call drop when performing the handoff, the quality of speech is satisfactory.

As described above, the security is excellent. The speech security can be maintained due to an encryption according to digitalization of the analog signal, a limitation of a wiretap according to a broadband method, and an encryption according to Pseudo Noise (PN) codes usage by each of users. In addition, high quality data service can be provided, power consumption in the mobile station can be reduced, and miniaturization and lightweight terminals can be realized.

CDMA is a technique whereby all users share the same frequency at the same time. Obviously, since all users share the same frequency simultaneously, they all interfere with each other. The challenge is to pick out the signal of one user from all of the other signals on the same frequency. This can be done if the signal from each user is modulated with a unique code sequence, where the code bit rate is far higher than the bit rate of the information being sent. At the receiving end, knowledge of the code sequence being used for a given signal allows the signal to be extracted.

Although CDMA had been considered for commercial mobile communications services by several bodies, it was never considered a viable technology until 1989 when a CDMA system was demonstrated by Qualcomm in San Diego, Calif. At the time, great claims were made about the potential capacity improvement compared to AMPS, as well as the potential improved voice quality and simplified system planning. Many people were impressed with these claims and the Qualcomm CDMA system was standardized as IS-95 in 1993 by the U.S. Telecommunications Industry Association (TIA).

The CDMA system utilizes a chip rate of 1.228 MHz. The chip rate is the rate at which the initial data stream, the original information, is encoded and then modulated. The chip rate is the data rate output of the PN generator of the CDMA system. A chip is simply a portion of the initial data or message that is encoded through use of a XOR process. The receiving system also must despread the signal utilizing the exact same PN code sent through an XOR gate that the transmitter utilized in order to properly decode the initial signal. If the PN generator utilized by the receiver is different or is not in synchronization with the transmitter's PN generator, then the information being transmitted will never be properly received and will be unintelligible.

The heart of CDMA lies in the point that the spreading of the initial information distributes the initial energy over a wide bandwidth. At the receiver, the signal is despread through reversing the initial spreading process where the original signal is reconstructed for utilization. When the CDMA signal experiences interference in the band, the despreading process despreads the initial signal for use but at the same time spreads the interference so it minimizes its negative impact on the received information.

The CDMA system is composed of a Mobile Station (MS), a Base station Transceiver Subsystem (BTS), a Base Station Controller (BSC), a Base Station Manager (BSM), a Mobile Switching Center (MSC), and a Home Location Register (HLR). The MS is a terminal with which a subscriber can communicate using a mobile communication network. The BTS is a system that is wirelessly connected to the MS so that it controls the MS and enables a traffic channel to be connected.

The BTS is a device constructed of a radio transceiver, which communicates with the terminal through a wireless link. The BSC controls a plurality of BTSs and is in charge of radio channel setup, frequency hopping, and handover process. It may be said that the BSC is a device that connects the BTS to the MSC.

The BSC controls wireless and wired links and performs a connection with another communication network. While the entire structures of the mobile communication system are similar regardless of the cellular methods, a factor that discriminates CDMA from the conventional method is an interface that connects the mobile station to the base station transceiver subsystem. The interface divides frequencies and discriminates the channel in the conventional method, and divides codes and discriminates the traffic channel according to IS-95 in CDMA.

The most important one in the CDMA system is the MSC. The MSC is similar to a switch in the PSTN, which is in charge of mobility management, location registration/management, authentication, handover, and roaming. The HLR and the Visitor Location Register (VLR) provide call routing and roaming functions together with the MSC.

The HLR holds subscriber information and location information of the terminal, and the location information of the terminal is included in a signaling address of the VLR. Only one HLR is installed in a network, and comprises a distributed database. The VLR stores a part (that is, the current location of the terminal) of information on the HLR, which is information that is associated with call control and service provision. While the VLR may be independently provided, a recent trend is that it is included in the MSC.

The BTS provides an interface through a wired connection with the BSC and radio connection between CDMA personal stations, and then basically provides information on a radio interface with the MS, a call processing function with respect to a mobile subscriber, and the BSC/MS. The main function of the BTS includes an RF interface function with respect to the MS, a BCS interface function, a function of BTS resource management and operation/maintenance, and a GPS reception function.

The BSC performs the BTS control, radio resource management, and soft/hard handoff with the BTS and with the BSC. The BTS is matched with the BSC using an E1 or T1 link, and is internally divided into a radio portion and a digital portion so that it performs the functions of radio connection, synchronization maintenance, and traffic channel assignment/release of the mobile station, that is, the terminal.

The BTS, to which IS-95C being recently standardized is applied, effects an increase of its capacity according to a shape of the BTS device, for example, making multiple sectors or increasing the number of transmission frequencies (FAs). The BTS includes a main controller, a baseband processor to modulate and demodulate the CDMA, an RF transceiver to wirelessly transmit and receive data to and from the mobile station, a line interface to match with the BSC, and a power supply.

The IS-95C BTS described above has internal function blocks each of which is formed on one board so that the IS-95C BTS is generally includes a plurality of boards. Therefore, there is a disadvantage in that its structure is complicated. Also, since the IS-95C BTS is installed and operated in a place where there are many users, when installing a large capacity base station transceiver subsystem, there are disadvantages in that a shadowed area occurs where cell radiuses are not overlapped and it is too costly to install a base station transceiver subsystem in a place where there are not many users. Accordingly, in order to solve the above problems, a small-sized base station transceiver subsystem has been developed, where a BTS is internally divided into an RF portion and a digital portion in the CDMA system and is arranged on a single board.

A determination as to whether a specific area is to be covered by the base station transceiver subsystem or by a repeater in a CDMA wireless network design is an important design factor that should be carefully made by comparing and analyzing the quality of the wireless network and its economical efficiency. In order to cover a partial shadowed area that occurs due to a weak electric field intensity, it is common to install a repeater to re-amplify the signal of the base station transceiver subsystem.

When a base station transceiver subsystem using a plurality of FAs and a small-sized CDMA base station transceiver subsystem that uses a single FA or FAs whose number is less than that of the base station transceiver subsystem are adjacently positioned, a call-drop can frequently occur. That is, when a FA is commonly used between the base station transceiver subsystem and the small-sized base station transceiver subsystem, a handoff can be performed when the terminal is moved. However, whenever both base station transceiver subsystems use FAs that are different from each other, a call-drop happens.

Accordingly, a beacon signal that initiates the handoff by transmitting a virtual electric wave that is identical with an electric wave environment around the CDMA small-sized base station transceiver subsystem is generated, that is, a currently used FA is generated and radiated with a size similar to a traffic FA. When a handoff parameter is inputted with respect to the neighboring base station transceiver subsystem, the traffic can be connected without a call-drop. In order to perform such a beacon function, a base station transceiver subsystem for the beacon must be separately added.

When an antenna of a base station transceiver subsystem is installed, a large part of the installation cost is consumed in installing a repeater. In order for the FA to be increased in the small-sized base station transceiver subsystem, one or more small-sized base station transceiver subsystems must be separately added.

Accordingly, in the process of implementing the FA increase and the beacon function, there is a problem in that a considerable additional cost occurs as one or more additional small-sized base station transceiver subsystems are added.

### SUMMARY OF THE INVENTION

It is, therefore, an object of the present invention to increase FAs by adding an RF module including a radio transceiver and a digital logic circuit on a board that is separate from a small-sized base station transceiver subsystem without adding a small-sized base station transceiver subsystem.

It is another object of the present invention to implement a beacon function in which a pilot channel is transmitted to perform a handoff of a terminal with a beacon module board connected to a small-sized base station transceiver subsystem.

According to an aspect of the present invention, the present invention provides a system comprising: a first base station transceiver subsystem adapted to assign a frequency to transmit and receive wireless data to and from a terminal; and at least one RF module adapted to assign at least one frequency different from the frequency assigned by the first base station transceiver subsystem in accordance with a control signal from the first base station transceiver subsystem.

The first base station transceiver subsystem preferably comprises: a modem adapted to modulate data transmitted from a base station controller and to generate a base band signal; a digital logic circuit adapted to divide and process a signal for the first base station transceiver subsystem and a signal for the RF module control from the base band signal received from the modem in accordance with a previously inputted program; and a radio transceiver adapted to modulate a signal of the digital logic circuit and to assign a frequency of the signal.

The radio transceiver preferably comprises: a Digital to Analog (D/A) converter adapted to convert digital data transmitted from the digital logic circuit into an analog signal; and an Analog to Digital (A/D) converter adapted to convert an analog signal transmitted from the terminal into digital data.

The at least one RF Module preferably comprises: a digital logic circuit adapted to interface with the first base station transceiver subsystem and to transmit and receive data in accordance with a previously inputted instruction; and a radio transceiver adapted to modulate a signal received from the digital logic circuit and to assign at least one frequency different from the frequency assigned by the first base station transceiver subsystem.

The radio transceiver preferably includes: a Digital to Analog (D/A) adapted to convert digital data of the digital logic circuit into an analog signal; and an Analog to Digital (A/D) converter adapted to convert an analog signal transmitted from the terminal into digital data.

According to an aspect of the present invention, the present invention provides a method comprising: receiving data from a base station controller, the data being received by a modem in a first base station transceiver subsystem; processing the data transmitted from the base station controller and assigning a frequency of the first base station transceiver subsystem to transmit and receive data to and from the terminal, the processing and assigning being performed by the first base station transceiver subsystem; and assigning at least one frequency different from the frequency of the first base station transceiver subsystem to an RF module connected to the first base station transceiver subsystem in accordance with a control signal from the first base station transceiver subsystem.

Receiving data from a base station controller preferably comprises dividing a signal for the first base station transceiver subsystem from the RF module control signal in accordance with a previously inputted program, the dividing being performed by a digital logic circuit in the first base station transceiver subsystem.

Receiving data from a base station controller preferably comprises modulating the signal received from the digital logic circuit and assigning the frequency of the first base station transceiver subsystem to transmit and receive the data to and from the terminal, the modulating and assigning being performed by a radio transceiver in the first base station transceiver subsystem.

Assigning at least one frequency different from the frequency of the first base station transceiver subsystem to an RF module preferably comprises modulating a signal received from the digital logic circuit in accordance with the previously inputted instruction to the digital logic circuit and assigning at least one frequency different from the frequency of the first base station transceiver subsystem, the modulating and assigning being performed by a radio transceiver.

According to an aspect of the present invention, the present invention provides a system comprising: a base station transceiver subsystem adapted to wirelessly transmit and receive data to and from a terminal; and a beacon module adapted to generate at least one different beacon frequency to perform a handoff of the terminal in accordance with a beacon frequency generation control signal from the base station transceiver subsystem and to sequentially transmit the beacon frequency to the terminal.

The base station transceiver subsystem preferably comprises: a modem adapted to modulate data transmitted from a base station controller and to generate a base band signal; a digital logic circuit adapted to divide and process a signal for the base station transceiver subsystem and a signal for the beacon module from the base band signal received from the modem in accordance with a previously inputted instruction; and a radio transceiver adapted to modulate the signal received from the digital logic circuit and to assign a frequency of the base station transceiver subsystem.

The beacon module preferably comprises: a digital logic circuit adapted to generate beacon frequency generation data in accordance with a beacon frequency generation control signal from the base station transceiver subsystem; and a radio transceiver adapted to generate at least one different beacon frequency by modulating the beacon frequency generation data generated by the digital logic circuit, and to sequentially transmit the beacon frequency to the terminal.

According to an aspect of the present invention, the present invention provides a method comprising: modulating and demodulating a received signal and transmitting the signal to the outside, the modulating and demodulating and transmitting being performed by a radio transceiver; processing data transmitted from the modem and assigning a frequency of a base station transceiver subsystem to transmit and receive the data to and from a terminal, the processing and assigning being performed by the base station transceiver subsystem; and processing the data transmitted from the base station transceiver subsystem and sequentially transmitting beacon frequencies to perform a handoff of the terminal, the processing and transmitting being performed by a beacon module.

Modulating and demodulating a received signal and transmitting the signal to the outside preferably comprises dividing a signal for the base station transceiver subsystem from a signal for the beacon module and respectively transmitting the signals to the base station transceiver subsystem and the beacon module, the dividing and transmitting being performed by a digital logic circuit in the base station transceiver subsystem.

Modulating and demodulating a received signal and transmitting the signal to the outside preferably comprises modulating a signal received from a digital logic circuit and assigning the frequencies for the base station transceiver subsystem to transmit and receive the data to and from the terminal, the modulating and assigning being performed by a radio transceiver in the base station transceiver subsystem.

Processing the data transmitted from the base station transceiver subsystem and sequentially transmitting beacon frequencies preferably comprises generating at least one different beacon frequency to perform a handoff of the module by modulating a base band signal received from the base station transceiver subsystem and sequentially transmitting the beacon frequency to the terminal, the generating and sequentially transmitting being performed by the beacon module.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a block diagram of a CDMA system;

FIG. 2 is a block diagram of a small-sized base station transceiver subsystem having an increased FA in accordance with an embodiment of the present invention;

FIG. 3 is a detailed block diagram of a small-sized base station transceiver subsystem having an increased FA in accordance with an embodiment of the present invention; and

FIG. 4 is a block diagram of a small-sized base station transceiver subsystem having a beacon module expansion for adding a beacon function in accordance with an embodiment of the present invention.

### DETAILED DESCRIPTION OF THE INVENTION

Hereinafter, the present invention is described more fully with reference to the accompanying drawings, in which exemplary embodiments of the present invention are shown. The present invention may, however, be implemented in different forms and should not be construed as being limited to the embodiments set fourth herein. Rather, these embodiments are provided so that this disclosure will be thorough and complete, and will fully convey the scope of the present invention to those skilled in the art.

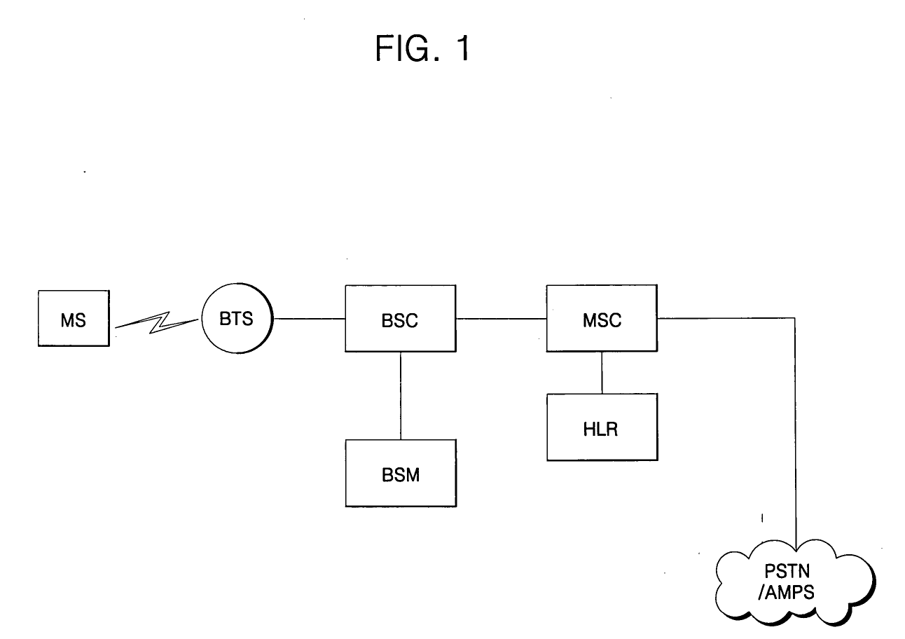

FIG. 1 is a block diagram of a CDMA system. The CDMA system comprises a Mobile Station (MS), a Base station Transceiver Subsystem (BTS), a Base Station Controller (BSC), a Base Station Manager (BSM), a Mobile Switching Center (MSC), and a Home Location Register (HLR). The MS is a terminal with which a subscriber can communicate using a mobile communication network. The BTS is a system that is wirelessly connected to the MS so that it controls the MS and enables a traffic channel to be connected. A detailed description of such a CDMA system is discussed above in the Description of the Related Art.

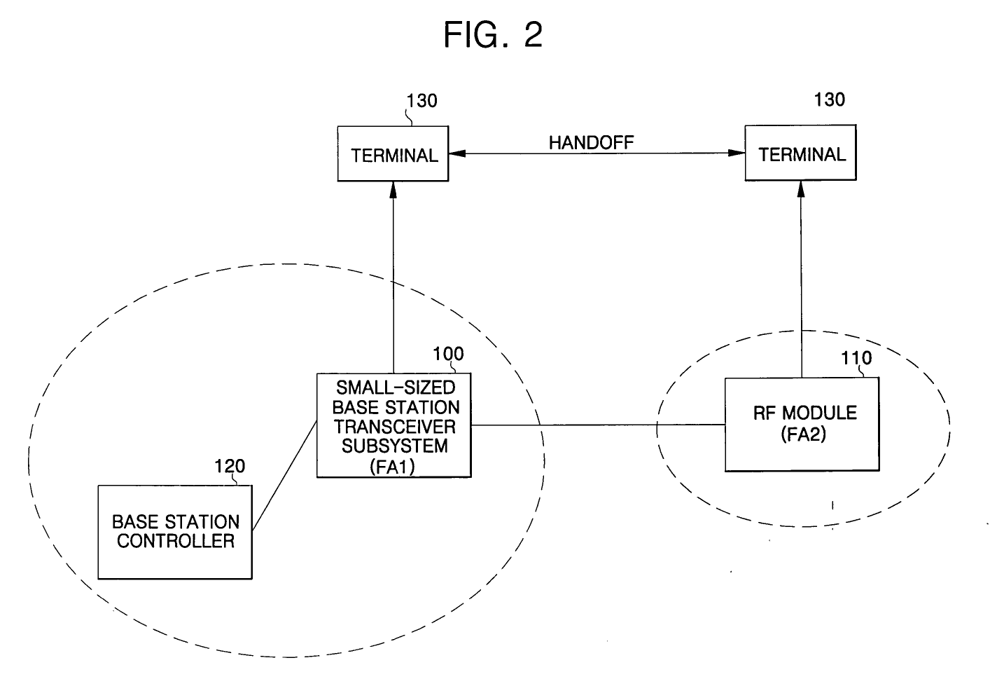

FIG. 2 is a block diagram of a small-sized base station transceiver subsystem having an increased FA in accordance with an embodiment of the present invention.

Referring to FIG. 2, a base station controller 120 controls a base station transceiver subsystem 100, radio resource management, and soft/hard handoff between the base station transceiver subsystem 100 and the base station controller 120.

A handoff is a function in which a terminal 130 moves from one base station transceiver subsystem 100 to another base station transceiver subsystem 100 but does not experience a call-drop and smoothly maintains the call while the terminal 130 is busy. There are three handoffs, that is, a soft handoff, a softer handoff, and a hard handoff.

The soft handoff is a handoff where there is no effect on the call when the terminal 130 moves from one base station transceiver subsystem 100 to another base station transceiver subsystem 100 while the terminal 130 is busy. The soft handoff connects the call by way of an intermediate process of simultaneously receiving signals from a plurality of base station transceiver subsystems. Such a handoff can be achieved only when the plurality of base station transceiver subsystems 100 have the same frequency.

The softer handoff is a handoff where a call is performed through two sectors in an area where electromagnetic waves overlap two sectors in the same base station transceiver subsystem 100 and is similar to the soft handoff method. However, it is not possible to simultaneously perform a handoff of three sectors. Since final modulation and demodulation procedures in the softer handoff are processed in the same modulator and demodulator chip, the handoff is performed very stably.

The hard handoff is a handoff where an instantaneous call-drop occurs when the terminal moves between the base station transceiver subsystems 100 but the call is connected to the next base station transceiver subsystem 100 without sensing the call-drop. The hard handoff has a lower chance of success than the soft handoff since it accompanies the instantaneous call-drop.

The base station transceiver subsystem 100 is matched to the base station controller 120 over an E1 or T1 link and is internally divided into a radio transceiver and a digital logic circuit, so that it effects a radio connection, maintains synchronization, and effects traffic channel assignment and release of the terminal 130 (a mobile station).

As described above, the present invention can increase the FA by adding the RF module 110 that implements the digital logic circuit and the radio transceiver on a single board, without installing a separate base station transceiver subsystem 100. Accordingly, the present invention increases the FA using a program inputted to the digital logic circuit of the added RF module 110, and a plurality of FAs can be added by adding a plurality of RF modules 110.

A small-sized base station transceiver subsystem can support the FA requested by a communication service provider by making selecting a proper RF module 110 from among the plurality of added RF modules.

The RF module 110 of the present invention can be replaced by a beacon module to perform a beacon function and the beacon module substitutes for a pilot beacon transmitter. An addition of the beacon module will be described later.

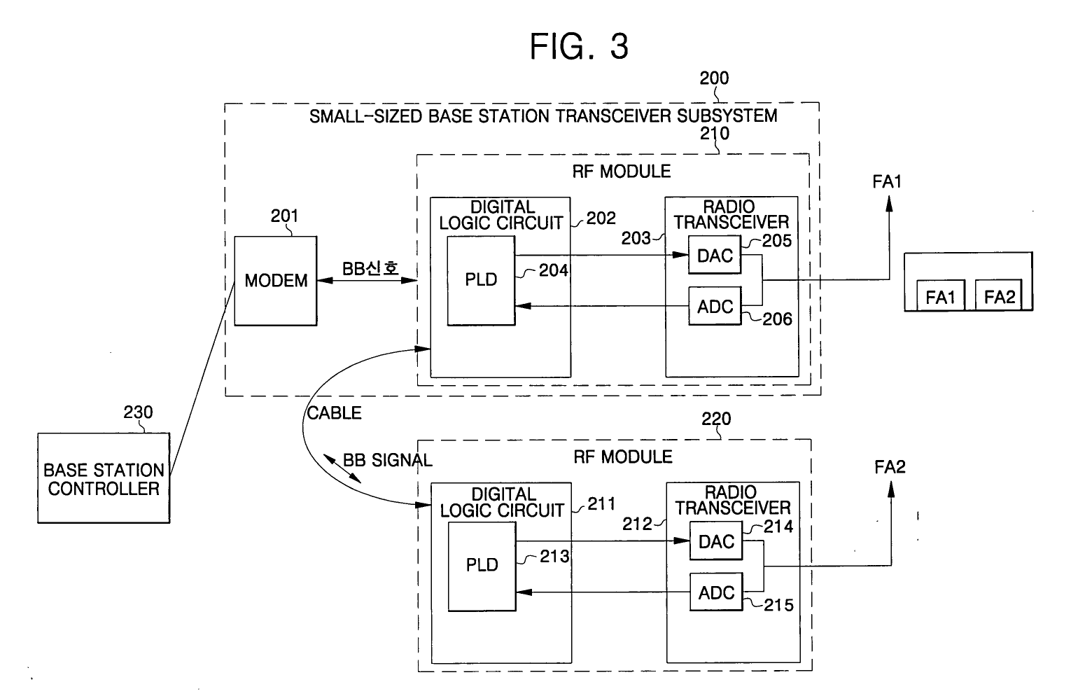

FIG. 3 is a detailed block diagram of a small-sized base station transceiver subsystem having an increased FA in accordance with an embodiment of the present invention. As described above, in the present invention, the FA is increased due to an addition of a base station transceiver subsystem 200 by adding an RF module 220 including a digital logic circuit 211 and a radio transceiver 212 on a single board.

As shown in FIG. 3, a small-sized base station transceiver subsystem 200 has an RF module 210 that includes a digital logic circuit 202, a radio transceiver 203, and a base station modem 201. The small-sized base station transceiver subsystem 200 can be connected to the outside via an ATM or IP network, and is generally connected to a base station controller 230.

The base station modem 201 outputs a modulated baseband signal which has a bandwidth of 1.2288 MHz with a central frequency of 0 Hz, or receives a baseband signal having a bandwidth of 1.2288 MHz and demodulates it. The modulated signal is transmitted to the digital logic circuits 202 and 211 of the RF modules 210 and 220, and the demodulated signal is transmitted to the base station controller 230.

The present invention can increase the FA separate from the small-sized base station transceiver subsystem 200 by separating the RF module 220 from a small-sized base station transceiver subsystem 200 and adding it as described above. Accordingly, it is possible to increase the FA without adding the separate base station transceiver subsystem.

As shown in FIG. 3, the RF modules 210 and 220 include the radio transceivers 203 and 212 and the digital logic circuits 202 and 211, and the FA can be increased by programming the digital logic circuits 202 and 211 of the RF modules 210 and 220.

The following is a description of how the digital logic circuit increases the FA in view of the transmission Tx and reception Rx. A baseband signal formed in the base station modem 201 upon transmitting can have three paths in the case of 1 FA3 sectors, one main path and the remaining two paths being used to increase the FA.

The main path is used in the small-sized base station transceiver subsystem 200 of the main base station transceiver subsystem, which is in charge of a frequency of FA1 formed in the RF module 210 of the main base station transceiver subsystem. The other two paths are used to increase the FA, which are in charge of FA2 and FA3 that are frequencies formed in the RF module 220 in order to increase the FA. FIG. 3 shows only an increase of the FA2 for convenience sake, and the FA3 has been omitted from FIG. 3.

In accordance with an embodiment of the present invention, the digital logic circuit 202 of the small-sized digital base station transceiver subsystem receives the baseband singal and transmits the baseband signal to the RF module 210 of the small-sized base station transceiver subsystem 200, and transmits voice and control signals that are baseband signals converted for a cable interface with respect to the added RF module 220, so that the FA is increased.

On the other hand, during receiving, the baseband signal formed in the RF module 220 to increase the FA is transmitted to the small-sized base station transceiver subsystem 200 via a cable and inputted to the base station modem 201 through a path which is different from that of the signal received in the RF module 210 of the small-sized base station transceiver subsystem 200.

Consequently, the present invention can support a plurality of FAs by remotely connecting the RF module 220 with a cable to one modem 201 to increase the FA.

Hereinafter, an operation of the present invention will be described in more detail. First of all, the radio transceivers 203 and 212 include Digital to Analog (D/A) converters 205 and 214 and Analog to Digital (A/D) converters 206 and 215, which upgrade the signal inputted in the digital logic circuits 202 and 211 to a final output and transmit the signal via an antenna.

The D/A converters 205 and 214 of the radio transceivers 203 and 212 convert digital data outputted by a Programmable Logic Device (PLD) to analog signals and transmit the signals to the radio transceivers 203 and 212, and the A/D converters 206 and 215 convert analog signals transmitted from the radio transceivers 203 and 212 to digital data.

As described above, the digital logic circuits 202 and 211 included on a single board together with the radio transceivers 203 and 212 include PLDs 204 and 213. The digital logic circuits 202 and 211 are interfaced with the base station controller 230 to control a call with respect to a terminal and to process a signal for maintenance via the radio transceivers 203 and 212 and an antenna. Also, the digital logic circuits 202 and 211 can alter an FA area according to a previously inputted program.

The digital logic circuit 202 of the small-sized base station transceiver subsystem can determine whether a signal is processed with respect to the RF module 220 to increase the FA by the previously inputted program. The plurality of RF modules 220 to increase the FA can be increased in accordance with an embodiment of the present invention.

In other words, when the RF module 220 to increase the plurality of FAs are added, the digital logic circuit 202 of the small-sized base station transceiver subsystem can select whether it is to be interfaced with the RF module 220 to increase the FA in accordance with the previously inputted program. Accordingly, it is possible to select only a specific RF module 220 from among the plurality of added RF modules 220.

The PLDs 204 and 213 of the digital logic circuits 202 and 211 transmit data of the base station controller 230 to the radio transceivers 203 and 212, or receive CDMA demodulated data and transmit the data to the base station controller 230.

Also, the PLDs 204 and 213 can process FA signals generated in the radio transceivers 203 and 212, respectively, and convert frequencies of the signals to arbitrary frequencies by altering the PLD program.

The modem 201 effects the CDMA modulation of the data transmitted from the base station controller 230 and then transmits the demodulated data to the PLDs 204 and 213, or effects the CDMA demodulation of the data transmitted from the PLDs 204 and 213 and then transmits the demodulated data to the base station controller 230.

A signal exchange between the modem 201 and the RF modules 210 and 220 is effected with a base band signal as described above.

When the RF module 220 is added, the baseband signal inputted via the modem 201 is transmitted to the digital logic circuit 211 in the added RF module 220 connected to the small-sized base station transceiver subsystem 200 via a cable, so that it is possible to increase FA separately from the small-sized base station transceiver subsystem 200. Accordingly, it is possible to increase the FA in the same manner that the small-sized base station transceiver subsystem 200 by adding the RF module 220.

A baseband signal exchange between the added RF module 220 and the small-sized base station transceiver subsystem 200 can be effected by the digital logic circuits 202 and 211 in the RF modules 210 and 220. That is, interfacing between the added RF module 220 and the small-sized base station transceiver subsystem 200 can be effected according to the program that has been previously set in the PLDs 204 and 213 inside the digital logic circuits 202 and 211.

In other words, the D/A converters 205 and 214 in the radio transceivers 203 and 212 convert digital data outputted by the PLDs 204 and 213 to analog signals, and then process the converted signals to a final output, that is, RF signals and transmit the final output. Also, when the RF signal is received, the D/A converters 205 and 214 process the RF signal and transmit the corresponding analog signal to the digital logic circuits 202 and 211 via the A/D converters 206 and 215.

The modem 201 effects the CDMA modulation of the data of the base station controller 230 and transmits the modulated data to the digital logic circuits 202 and 211, and the digital logic circuits 202 and 211 transmit the data to the radio transceivers 203 and 212.

The radio transceivers 203 and 212 process the signals outputted by the PLDs 204 and 213 of the digital logic circuits 202 and 211 to RF signals to be finally outputted and transmit the RF signals via the antenna.

On the contrary, when the RF signals are inputted into the small-sized base station transceiver subsystem via the antenna, the radio transceivers 203 and 212 of the small-sized base station transceiver subsystem lower the frequencies of the RF signals and then transmit the frequencies to the PLDs 204 and 213 of the digital logic circuits 202 and 211.

The A/D converters 206 and 215 of the radio transceivers 203 and 212 convert the inputted analog signals to digital data and then transmit the data to the digital logic circuits 202 and 211.

The PLDs 204 and 213 of the digital logic circuits 202 and 211 effect the CDMA demodulation of the data that have been converted to digital data by the A/D converters 206 and 215 and inputted via the modem 201 and transmit the demodulated data to the base station controller 230.

As described above, in accordance with an embodiment of the present invention, the baseband signal formed in the modem 201 of the small-sized base station transceiver subsystem 200 is transmitted to the separately added RF module 220 by the digital logic circuit 202 via a cable, and the transmitted baseband signal is modulated to FA2 that is a frequency previously set by the digital logic circuit 202 of the small-sized base station transceiver subsystem 200. That is, in accordance with an embodiment of the present invention, the separately added RF module 220 effects an increase in the FA with respect to a frequency set by the digital logic circuit 202 of the small-sized base station transceiver subsystem 200.

On the contrary, the received signal inputted to the added RF module 220 is demodulated to a baseband signal and then inputted to the small-sized base station transceiver subsystem 200 via the cable. The baseband signal received by the small-sized base station transceiver subsystem 200 is inputted to the modem 201 via the digital logic circuit 202 and then transmitted to the outside.

Consequently, in accordance with an embodiment of the present invention, it is possible to increase the FA being a wireless data transceiving channel by the added RF module 220 connected to the small-sized base station transceiver subsystem 200 without adding the separate base station transceiver subsystem.

According to another aspect of the present invention, it is possible to add the beacon function by expanding the beacon module in the small-sized base station transceiver subsystem.

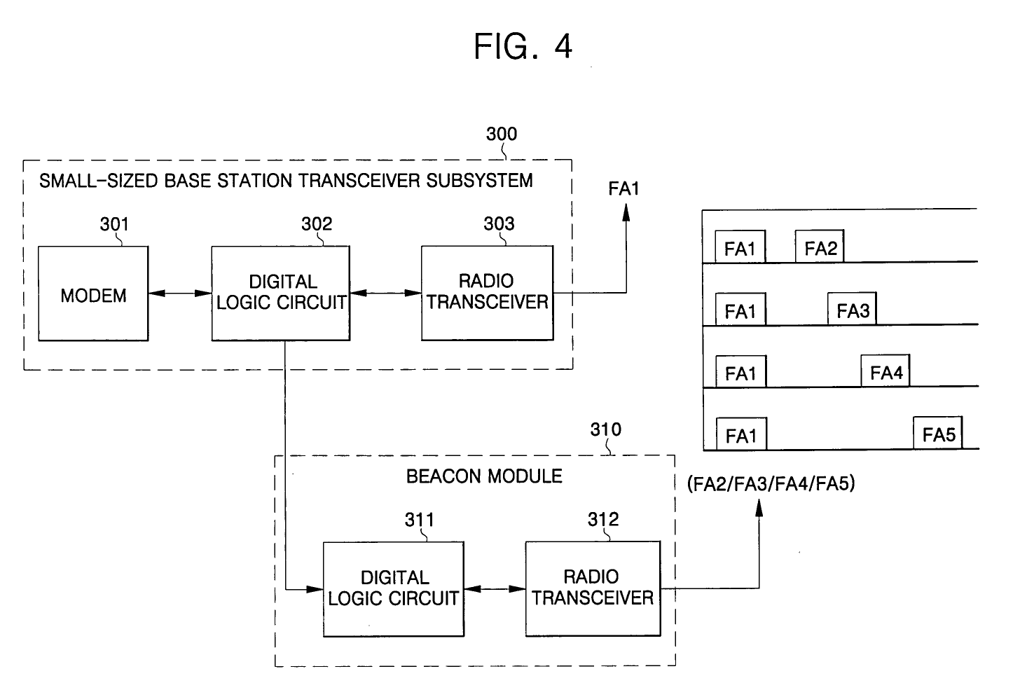

FIG. 4 is a block diagram of a small-sized base station transceiver subsystem having a beacon module expansion for adding a beacon function in accordance with an embodiment of the present invention.

According to circumstances, a charge area of the small-sized base station transceiver subsystem can be divided into a plurality of sectors and three sectors are generally used.

In other words, the mobile phone base station transceiver subsystem can be used by dividing it into a 120°, 60° or 45° sector system, and each sector is assigned the channel formed by dividing the total available channels into various service sets. The aim of dividing the base station transceiver subsystem into sectors is to reduce interference and to delay an increase of the base station transceiver subsystem in high traffic areas. When an angle of the sector is made too narrow in an attempt to reduce interference, the number of assigned channels is reduced so that a handoff occurs frequently and the efficiency of a trunk line of the radio channel is reduced.

When a mobile station, that is, a mobile terminal wishes to perform a handoff between frequencies, it is necessary to install a pilot beacon transmitter in the base station transceiver subsystem of the other party. The mobile terminal must have information on pilot channels in order to perform the handoff, and it is considered that the base station transceiver subsystems are classified from the mobile terminal's point of view.

In other words, in order that call processing is performed between the mobile terminal and the base station transceiver subsystem, the base station transceiver subsystem transmits the pilot channel to search the CDMA channel and to effect synchronization when the mobile terminal is in an initial state.

When a mobile terminal that continuously measures the intensity of signals of the pilot channels inputted from various sources determines that the intensity of a certain signal exceeds a fixed reference value while the mobile terminal is moving, the mobile terminal determines that it is in a handoff state after maintaining the same state for a predetermined time period and informs the base station transceiver subsystem of that fact. The base station transceiver subsystem then transmits a handoff-direction message to perform the call processing between the mobile terminal and the base station transceiver subsystem.

Assume that the mobile terminal leaves an area. When the intensity of the signals become lower than a fixed reference value and are maintained for a predetermined time period, the corresponding base station transceiver subsystem assumes that the terminal has left the area.

A pilot beacon transmitter must be installed in the base station transceiver subsystem to transmit the pilot channel in order to perform the call processing between the mobile terminal and the base station transceiver subsystem.

Another aspect of the present invention is characterized in that the beacon module 310 that transmits the pilot channel is provided separately from the small-sized base station transceiver subsystem 300 so that the beacon function can be performed.

In accordance with an embodiment of the present invention, the beacon module 310 is arranged to transmit the beacon frequencies FA2, FA3, FA4 and FA5 according to an instruction from the small-sized base station transceiver subsystem 300. The digital logic circuit 311 that adds the beacon function is provided only in the case of the transmission Tx.

The baseband signal path formed in the modem 301 upon transmitting includes a main path and a path to increase the FA. The main path is a path to be used in the small-sized base station transceiver subsystem 301 that is a main base station transceiver subsystem and controls the frequency FA1 to be formed in the RF module of the main base station transceiver subsystem. The other path is used for the beacon function, with which the frequencies FA2, FA3, FA4 and FA5 to be formed in the RF module 310 for the beacon function are transmitted in turn.

The digital logic circuit 302 of the small-sized base station transceiver subsystem 300 receives the baseband signal and then transmits the signal to the beacon module 310 that is added to perform the beacon function with the radio transceiver 303 of the small-sized base station transceiver subsystem 300.

As shown in FIG. 4, the digital logic circuit 302 in the small-sized base station transceiver subsystem 300 separates the signal for the beacon in the baseband signal inputted from the modem 301 from the signal for the base station transceiver subsystem, and transmits the separated signal to the beacon module 310. The digital logic circuit 311 can be implemented with a chip that has been previously programmed by a user, and transmission to the beacon module 310 with respect to the beacon signal is performed according to the program.

The signal for the beacon transmitted to the beacon module 310 is the baseband signal as described above, and includes information on the channel of a neighboring base station transceiver subsystem. The signal for the beacon transmitted to the beacon module 310 is inputted to the radio transceiver 312 via the digital logic circuit 311 and modulated to the beacon frequencies FA2, FA3, FA4 and FA5 to perform the pilot channel transmission with respect to the terminal.

The pilot channel includes information on the neighboring channel transmitted by the beacon module 310, which refers to the transmission of the minimum information on its base station transceiver subsystem to the terminal. The minimum information on its base station transceiver subsystem includes information on the channel of the neighboring base station transceiver subsystem.

Consequently, the radio transceiver 312 of the beacon module 310 sequentially transmits the beacon frequency, that is, the pilot channel with respect to the terminal, so that the handoff of the terminal can be performed according to the pilot channel transmission.

According to the present invention, an RF module that includes a radio transceiver and a digital logic circuit on one board can be added separately from a small-sized base station transceiver subsystem without adding the small-sized base station transceiver subsystem so that the FA can be increased and so that it can substitute for a separate addition of the base station transceiver subsystem. Also, the present invention can perform a beacon function to transmit a pilot channel by connecting the beacon module that includes the radio transceiver and the digital logic circuit on one board to the small-sized base station transceiver subsystem.

Although embodiments of the present invention have been described above, it is to be understood by those skilled in the art that the present invention is not limited to the described embodiments. Rather, various changes and modifications can be made within the spirit and scope of the present invention, as defined by the following claims.

1. A system comprising:
a first base station transceiver subsystem adapted to assign a frequency to transmit and receive wireless data to and from a terminal; and
at least one RF module adapted to assign at least one frequency different from the frequency assigned by the first base station transceiver subsystem in accordance with a control signal from the first base station transceiver subsystem.

2. The system according to claim 1, wherein the first base station transceiver subsystem comprises:
a modem adapted to modulate data transmitted from a base station controller and to generate a base band signal;
a digital logic circuit adapted to divide and process a signal for the first base station transceiver subsystem and a signal for the RF module control from the base band signal received from the modem in accordance with a previously inputted program; and
a radio transceiver adapted to modulate a signal of the digital logic circuit and to assign a frequency of the signal.

3. The system according to claim 2, wherein the radio transceiver comprises:
a Digital to Analog (D/A) converter adapted to convert digital data transmitted from the digital logic circuit into an analog signal; and
an Analog to Digital (A/D) converter adapted to convert an analog signal transmitted from the terminal into digital data.

4. The system according to claim 1, wherein the at least one RF Module comprises:
a digital logic circuit adapted to interface with the first base station transceiver subsystem and to transmit and receive data in accordance with a previously inputted instruction; and
a radio transceiver adapted to modulate a signal received from the digital logic circuit and to assign at least one frequency different from the frequency assigned by the first base station transceiver subsystem.

5. The system according to claim 4, wherein the radio transceiver includes:
a Digital to Analog (D/A) adapted to convert digital data of the digital logic circuit into an analog signal; and
an Analog to Digital (A/D) converter adapted to convert an analog signal transmitted from the terminal into digital data.

6. A method comprising:
receiving data from a base station controller, the data being received by a modem in a first base station transceiver subsystem;
processing the data transmitted from the base station controller and assigning a frequency of the first base station transceiver subsystem to transmit and receive data to and from the terminal, the processing and assigning being performed by the first base station transceiver subsystem; and
assigning at least one frequency different from the frequency of the first base station transceiver subsystem to an RF module connected to the first base station transceiver subsystem in accordance with a control signal from the first base station transceiver subsystem.

7. The method according to claim 6, wherein receiving data from a base station controller comprises dividing a signal for the first base station transceiver subsystem from the RF module control signal in accordance with a previously inputted program, the dividing being performed by a digital logic circuit in the first base station transceiver subsystem.

8. The method according to claim 6, wherein receiving data from a base station controller comprises modulating the signal received from the digital logic circuit and assigning the frequency of the first base station transceiver subsystem to transmit and receive the data to and from the terminal, the modulating and assigning being performed by a radio transceiver in the first base station transceiver subsystem.

9. The method according to claim 6, wherein assigning at least one frequency different from the frequency of the first base station transceiver subsystem to an RF module comprises modulating a signal received from the digital logic circuit in accordance with the previously inputted instruction to the digital logic circuit and assigning at least one frequency different from the frequency of the first base station transceiver subsystem, the modulating and assigning being performed by a radio transceiver.

10. A system comprising:
a base station transceiver subsystem adapted to wirelessly transmit and receive data to and from a terminal; and
a beacon module adapted to generate at least one different beacon frequency to perform a handoff of the terminal in accordance with a beacon frequency generation control signal from the base station transceiver subsystem and to sequentially transmit the beacon frequency to the terminal.

11. The system according to claim 10, wherein the base station transceiver subsystem comprises:
a modem adapted to modulate data transmitted from a base station controller and to generate a base band signal;
a digital logic circuit adapted to divide and process a signal for the base station transceiver subsystem and a signal for the beacon module from the base band signal received from the modem in accordance with a previously inputted instruction; and
a radio transceiver adapted to modulate the signal received from the digital logic circuit and to assign a frequency of the base station transceiver subsystem.

12. The system according to claim 10, wherein the beacon module comprises:
a digital logic circuit adapted to generate beacon frequency generation data in accordance with a beacon frequency generation control signal from the base station transceiver subsystem; and
a radio transceiver adapted to generate at least one different beacon frequency by modulating the beacon frequency generation data generated by the digital logic circuit, and to sequentially transmit the beacon frequency to the terminal.

13. A method comprising:
modulating and demodulating a received signal and transmitting the signal to the outside, the modulating and demodulating and transmitting being performed by a radio transceiver;
processing data transmitted from the modem and assigning a frequency of a base station transceiver subsystem to transmit and receive the data to and from a terminal, the processing and assigning being performed by the base station transceiver subsystem; and
processing the data transmitted from the base station transceiver subsystem and sequentially transmitting beacon frequencies to perform a handoff of the terminal, the processing and transmitting being performed by a beacon module.

14. The method according to claim 13, wherein modulating and demodulating a received signal and transmitting the signal to the outside comprises dividing a signal for the base station transceiver subsystem from a signal for the beacon module and respectively transmitting the signals to the base station transceiver subsystem and the beacon module, the dividing and transmitting being performed by a digital logic circuit in the base station transceiver subsystem.

15. The method according to claim 13, wherein modulating and demodulating a received signal and transmitting the signal to the outside comprises modulating a signal received from a digital logic circuit and assigning the frequencies for the base station transceiver subsystem to transmit and receive the data to and from the terminal, the modulating and assigning being performed by a radio transceiver in the base station transceiver subsystem.

16. The method according to claim 13, wherein processing the data transmitted from the base station transceiver subsystem and sequentially transmitting beacon frequencies comprises generating at least one different beacon frequency to perform a handoff of the module by modulating a base band signal received from the base station transceiver subsystem and sequentially transmitting the beacon frequency to the terminal, the generating and sequentially transmitting being performed by the beacon module.
